(19) United States
(12) Patent Application Publication
(10) Pub. No.: US 2002/0159756 A1
(43) Pub. Date: Oct. 31, 2002

(54) Video data and web page data coexisted compact disk

(76) Inventor: Cheng-Tao Paul Lee, Taipei City (TW)

Correspondence Address: SUPREME PATENT SERVICES, POST OFFICE BOX 2339, SARATOGA, CA, 95070, US

(21) Appl. No.: 09/843,375

(22) Filed: Apr. 25, 2001

(51) Int. Cl. H04N 5/91; H04N 7/04; H04N 7/06; H04N 7/08; H04N 7/52; H04N 5/781; H04N 5/85; H04N 5/90

(52) U.S. Cl. 386/95; 386/125

(57) ABSTRACT

A video data and web site data stored compact disk (CD) comprises: a first data zone for storing and providing video data to a VCD player for reproduction, and a second data zone for storing and providing video data of a plurality of web pages for a browser to execute hypertext link with the first data zone, so that the VCD player can perform playback of the video data stored in the first data zone when the CD is placed in the VCD player or the browser can access the web pages when the CD is placed in a computer.

### FIELD OF THE INVENTION

This invention relates generally to a compact disk (CD), particularly to a compact disk in which video data and web page data are coexisted.

### BACKGROUND OF THE INVENTION

When a video compact disk (VCD/DVD/SVCD) is driven by a CD player or by a playback software in a computer, people can view pictures or movies displayed in a TV screen or a computer monitor. However, so far, the video data in a compact disk cannot be availed to linking of a computer with an e-business web site for selection and purchase of movie pictures.

### SUMMARY OF THE INVENTION

The primary object of this invention is to provide a compact disk, in which data can be reproduced by a VCD (video compact disk) player or accessed by a browser in a computer and furthermore linked with an e-business web site.

In order to realize abovesaid objects, a video data and web site data stored CD comprises: a first data zone for storing and providing video data to a VCD player for reproduction, and a second data zone for storing and providing video data of a plurality of web pages for a browser to execute hypertext link with the first data zone, so that the VCD player can perform playback of the video data stored in the first data zone when the CD is placed in the VCD player or the browser can access the web pages when the CD is placed in a computer.

For more detailed information regarding advantages or features of this invention, at least an example of preferred embodiment will be elucidated below with reference to the annexed drawings.

### BRIEF DESCRIPTION OF THE DRAWINGS

The related drawings in connection with the detailed description of this invention, which is to be made later, are described briefly as follows, in which:

FIG. 1 is a directory of a CD embodiment of this invention;

FIG. 2 is a schematic view showing that a user is playing a VCD player for playback of the CD of this invention;

FIG. 3 is a schematic view showing that a user is browsing the CD of this invention with a browser;

FIG. 4 is a typical example of the display shown in FIG. 3; and

FIG. 5 is a typical example showing that a user is using the CD of this invention to link with a default web site.

### DETAILED DESCRIPTION OF THE PREFERRED EMBODIMENT

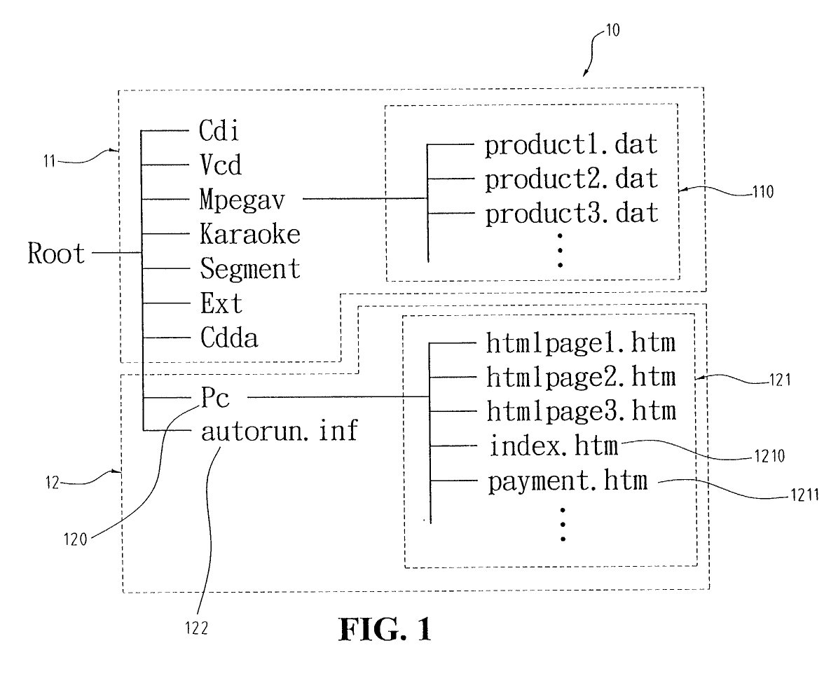

As illustrated in FIG. 1, a compact disk (CD) 10 comprises a first data zone 11 and a second data zone 12.

The first data zone 11 is provided for storing video data and offering the same to a video CD (DVD/VCD/SVCD) player for playback, and this data zone can be formatted in VCD, SVCD, or DVD. In VCD format shown in FIG. 1, a root directory of the CD 10 in the first data zone 11 comprises a plurality of directories including “Cdi”, “Vcd”, “Mpegav”, “Segment”, “Ext”, “Cdda”, wherein the “Mpegav” directory further comprises a plurality of video files 110, containing “product1.dat”, “product2.dat”, “product3.dat”, etc. When the CD 10 is placed in the VCD (video compact disk) player, playback of the video files 110 in the first data zone 11 can be performed sequentially, that is, the pictures and sounds of the file “product1.dat”, “product2.dat”, “product3.dat” can be presented in a TV screen.

The second data zone 12 is provided for storing a plurality of web page linking files 121 and offering the same to a computer's browser for hypertext link with the video files 110 in the first data zone 11. The CD 10 of this invention further contains an autorun file 122 which is to be executed automatically when the CD 10 is put into a computer, wherein the autorun file 122 contains at least a command for execution of a browser so that the computer can run the browser and access the web page linking files 121. A typical syntax of the autorun file 122 is as the follows:

[autorun]

OPEN=EXPLORER.EXE\Pc\index.htm

ICON=xxxx.ico

where a computer runs the browser “EXPLORER.EXE” to access “\Pc\index.htm” 1210 in the web page linking files 121.

For e-business application, in the video files 110 of the first data zone 11, the “product1.dat” is a movie for showing company (A)'s cellular phones; the “product2.dat” is a movie for showing company (B)'s cosmetics; and the “product3.dat” is a movie for showing company (C)'s home electric appliances. Therefore, when a user is playing a CD player with the CD 10 of this invention, he keeps himself informed of company (A)'s cellular phones, company (B)'s cosmetics, and company (C)'s home electric appliances in the video files of the first data zone 11.

A web page “htmlpage1.htm” of the web page linking files 121 in the second data zone 12 of the CD 10 is a web page regarding company (A)'s cellular phones, wherein the web page program codes of the “htmlpage1.htm” should contain at least a code for hypertext link to the “product1.dat” so that a user can view the movie of the “product1.dat” regarding company (A)'s cellular phones while he is using a browser to browse the web page—“htmlpage1.htm”. Similarly, he can view the movie of the “product2.dat” regarding company (B)'s cosmetics or the movie of the “product3.dat” regarding company (B)'s home electric appliances while he is using the browser to browse a web page—“htmlpage2.htm” or “htmlpage3.htm”. In a practical embodiment, the web page linking files 121 of the abovesaid plurality of web pages may be stored concentrically under a directory “Pc” 120, and the web page linking files i21 are coded in the HyperText Markup Language (HTML).

In the web page linking files 121 of the second data zone 12, at least a linking file is available for linking with a default web site. In a substantial embodiment of this invention, a web page linking file “payment. htm” 1211, which contains in its codes at least an instruction for linking with a default web site, is provided such that a user may use a browser to browse web pages, select goods, and link to enter a default web site to proceed payments.

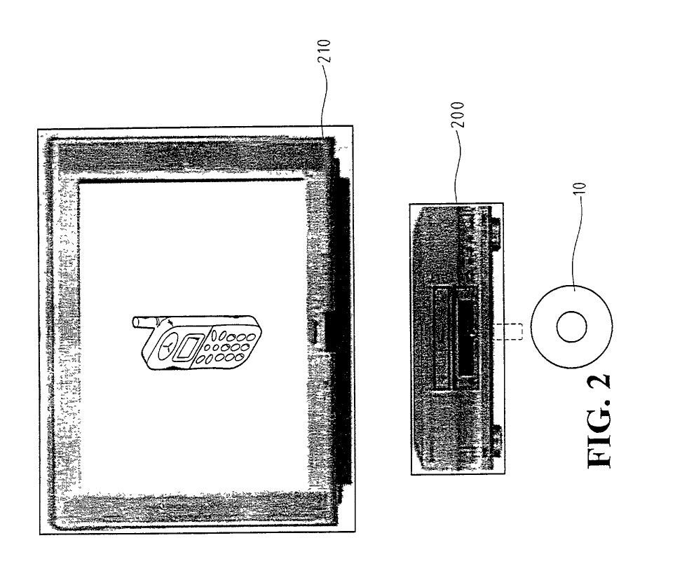

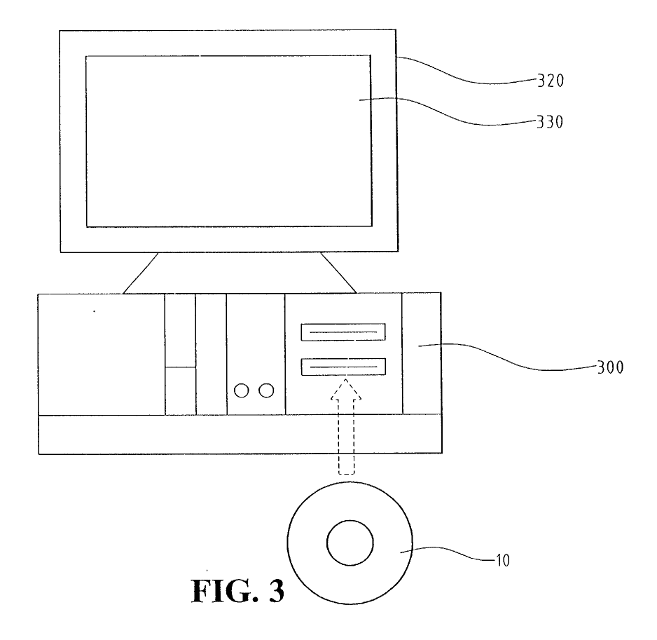

As illustrated in FIG. 2—a schematic view showing that a user is playing a VCD player for playback of the CD of this invention—the CD 10 is played by a VCD player 200, and the user may sit in front of a TV set 210 and watch a plurality of movies edited on basis of the video data 110 in the first data zone 11 of the CD 10. FIG. 3 is a schematic view showing that a user is browsing the CD of this invention with a browser. In this example, a user runs a browser in a computer 300 to browse the CD 10, and a plurality of htmlpages 330 of the web page linking files 121 in the second data zone of the CD 10 is shown in a display 320.

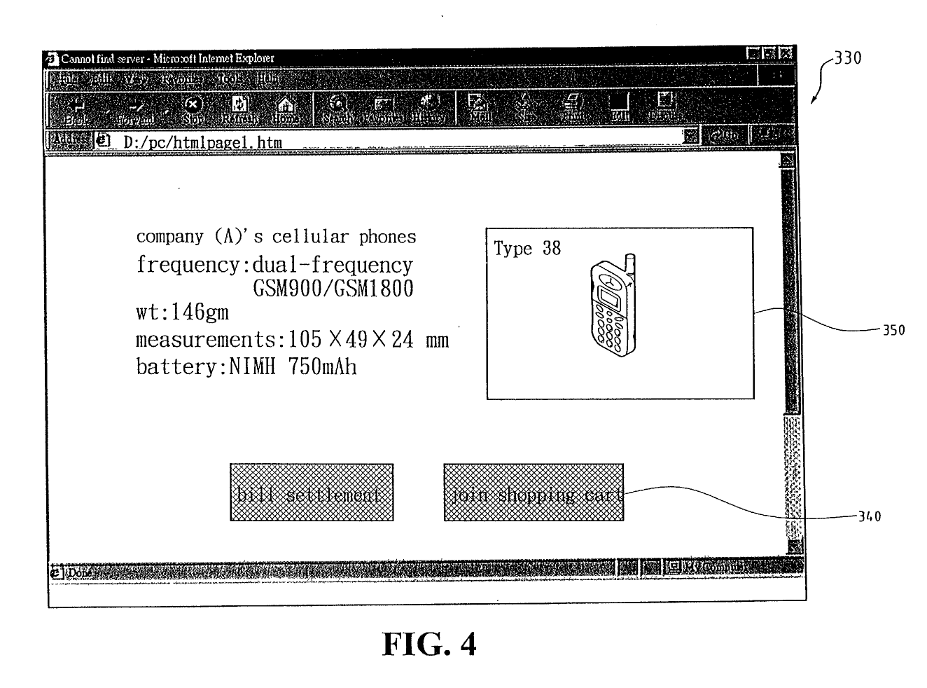

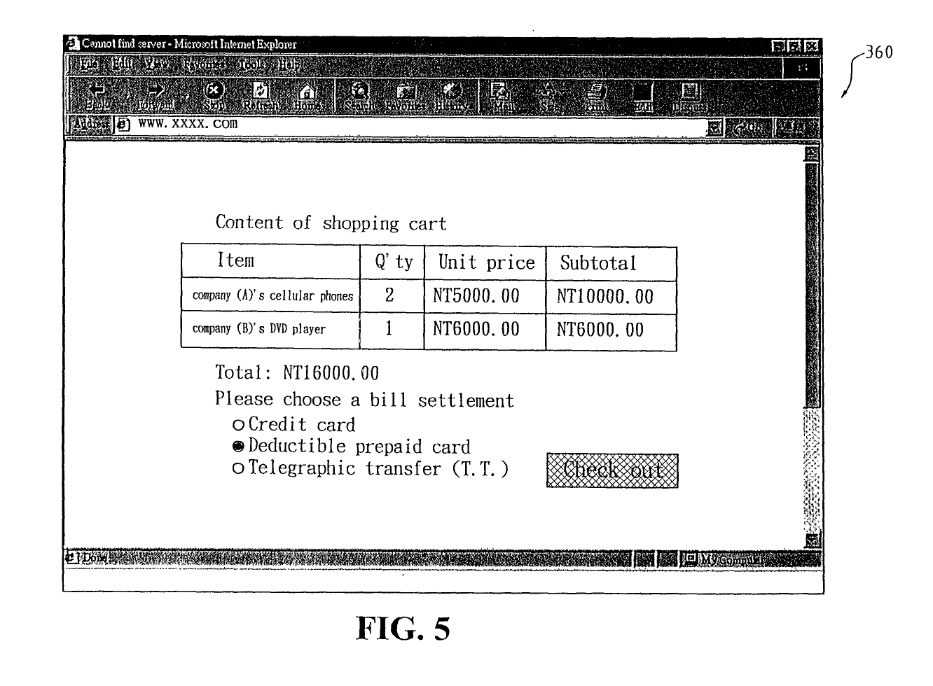

In a typical example of the display of FIG. 3 shown in FIG. 4, a display zone 350 is used for playback and showing the video data 110 in the first data zone 11, such as a movie for sales promotion of company (A)'s cellular phones. FIG. 5 is a typical example showing that a user is using the CD of this invention to link with a default web site. In this figure, the picture frame 360 expresses a substantial embodiment of abovesaid web page linking file “payment. htm” 1211, and a user may click the icon 340 to link with a default web site, such as “www. xxxx. com”, etc.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. A compact disk (CD), comprising:
a first data zone for storing video data and providing the same to a video compact disk (VCD) player; and
a second data zone for storing a plurality of web page linking files and providing the same to a computer browser, which can perform hypertext link with the video data of the first data zone;
whereby the VCD player will perform playback of the video data stored in the first data zone if the CD is placed in the VCD player, or a computer will run a browser to access the web page linking files if the CD is placed in the computer.

2. The compact disk (CD) according to claim 1, wherein the video data in the first data zone are VCD-formatted.

3. The compact disk (CD) according to claim 1, wherein the video data in the first data zone are SVCD-formatted.

4. The compact disk (CD) according to claim 1, wherein the video data in the first data zone are DVD-formatted.

5. The compact disk (CD) according to claim 1, wherein the second data zone further contains an autorun file so that the computer will run an inside browser to access the web page linking files when the compact disk is placed in the computer.

6. The compact disk (CD) according to claim 1, wherein at least one of the web page linking files is capable of linking with a default web site.

7. The compact disk (CD) according to claim 1, wherein the web page linking files of the second data zone are coded in HyperText Markup Language (HTML).
